(19) United States
(12) Patent Application Publication
(10) Pub. No.: US 2008/0144708 A1
(43) Pub. Date: Jun. 19, 2008

(54) METHOD AND APPARATUS FOR EQUALIZATION

(75) Inventors: Yih-Ming Tsuie, Hsinchu City (TW); Chiao-Chih Chang, Taipei City (TW); Wei-Ting Wang, Yilan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/612,851

(22) Filed: Dec. 19, 2006

(51) Int. Cl. H04B 17/00

(52) U.S. Cl. 375/227

(57) ABSTRACT

An equalization circuit and an equalization method implemented thereby are provided. A received symbol is received to generate a equalizer output. In the equalization circuit, an equalizer performs equalization to the received symbol based on a SNR value of the equalizer output. A SNR estimator coupled to the output of equalizer receives the equalizer output to measure the SNR value. The equalizer equalizes the received symbol by the LMS algorithm in which coefficients are recursively updated by a step size, and the step size is adjusted based on the SNR value.

### BACKGROUND OF THE INVENTION

1. Field of the Invention

The invention relates to adaptive equalization, and in particular, to step size optimization according to SNR of received symbols.

2. Description of the Related Art

A typical equalizer utilizes a least mean square (LMS) algorithm to update coefficients therein. The equalizer outputs equalizer output y(n) corresponding to a symbol time n, a linear filter output plus a decision feedback output:

$$y ( n ) = {\sum }_{k} r ( n + k ) \cdot {c}_{- k} ( n ) + {\sum }_{k} d ( n - k ) \cdot {c}_{k} ( n ) \qquad ( 1 )$$

where r(n) is the received symbol, d(n) is a decision result of the r(n), and k represents the tap number of the linear filter and decision feedback filter.

An error between the d(n) and equalizer output y(n) is estimated:

e(n)=d(n)−y(n) (2)

and the coefficients of linear filter and decision feedback filter are updated based on the LMS algorithm:

cₖ(n+1)=cₖ(n)+μ·e*(n)·d(n−k) (3)

c₋ₖ(n+1)=c₋ₖ(n)+μ·e*(n)·d(n+k) (4)

where μ is the step size defined by the LMS algorithm, cₖ(n) is a k^{th} linear filter coefficient, and c₋ₖ(n) is a k^{th} decision filter coefficient. From equation (2), mean square error (MSE) can be computed:

MSE=E{|e(n)|}=E{|d(n)−y(n)|²} (5)

FIG. 1 shows MSE curves of various step sizes, in which three MSE curves each correspond to a different step size μ, a, b and c, where a>b>c. The curve of higher step size converges fast, and saturates at higher MSE value, such as curve μ=a. On the contrary, the curve of lower step size converges slow, and saturates at lower MSE value, such as curve μ=c. Additionally, it can be seen that MSE of lower step size has better stability than that of high. From the MSE, signal to noise ratio (SNR) of the equalizer output can be further computed:

$$SNR = 10 \cdot {log}_{10} \frac{S}{MSE} \qquad ( 6 )$$

where S is an expectation or all possible symbol values:

S=E{±1,±3,±5,±7} (7)

FIG. 2 shows SNR curves derived from MSE. After the equalization is initialized, the SNR gradually increases and eventually saturates at a level. Different step size renders different saturation level with different convergence rate. For example, the largest step size μ=a converges fastest, but the saturation level is lowest, whereas the lowest step size μ=c converges slow, having a higher saturation level, causing a tradeoff between high SNR and high convergence rate. An improved equalization method may be desirable to obtain both advantages of rapid convergence and high SNR equalizer output.

### BRIEF SUMMARY OF THE INVENTION

A detailed description is given in the following embodiments with reference to the accompanying drawings.

A exemplary embodiment of an equalization circuit implementing an equalization method is provided. A received symbol is received to generate an equalizer output. In the equalization circuit, an equalizer performs equalization on the received symbol based on a SNR value of the equalizer output. A SNR estimator coupled to the output of the equalizer receives the equalizer output to measure the SNR value. The equalizer equalizes the received symbol by the LMS algorithm in which coefficients are recursively updated by a step size, and the step size is adjusted based on the SNR value.

The equalizer comprises a coefficient updater and a step size controller. The coefficient updater continuously updates the coefficients based on the step size. The step size controller is coupled to the coefficient updater, continuously receiving the SNR value to calculate the step size for the coefficient updater. The SNR value is periodically measured and sent to the equalizer. The step size controller analyzes variation in at least two consecutive SNR values measured within a period, and determines the necessity to adjust the step size based on the variation analysis. When the necessity is determined, the step size controller reduces the step size to a lower level, otherwise the step size is left as is. The necessity is determined based on the variation converging below a threshold.

The step size controller further determines whether most recent step size reduction is effective, and if not, the step size is left as is. The step size reduction is deemed effective if the SNR value increases after step size reduction. The equalizer output comprises a field sync stream and a plurality of segments headed with segment sync symbols, and the SNR estimator outputs the SNR every segment period, comprising a field sync SNR calculator, a segment sync SNR calculator and a selector. The field sync SNR calculator estimates a field sync SNR from the field sync symbol stream. The segment sync SNR calculator periodically estimates segment sync SNRs from the segment sync symbols in every segment. The selector is coupled to the segment sync SNR calculator and field sync SNR calculator, comparing the segment sync SNR with the field sync SNR every segment period. If the difference between the segment sync SNR and the field sync SNR exceeds a predetermined threshold, the selector outputs the field sync SNR as the SNR value, otherwise the selector outputs the segment sync SNR as the SNR value.

### BRIEF DESCRIPTION OF THE DRAWINGS

The invention can be more fully understood by reading the subsequent detailed description and examples with references made to the accompanying drawings, wherein.

FIG. 1 shows MSE curves of various step sizes;

FIG. 2 shows SNR curves derived from MSE;

FIG. 3 shows an embodiment of an equalization circuit;

FIG. 4 is a flowchart of the step size determination according to an embodiment of the invention;

FIG. 5 is a diagram of field sync and segement sync with corresponding SNR values; and

FIG. 6 is a flowchart of the SNR measurement according to an embodiment of the invention.

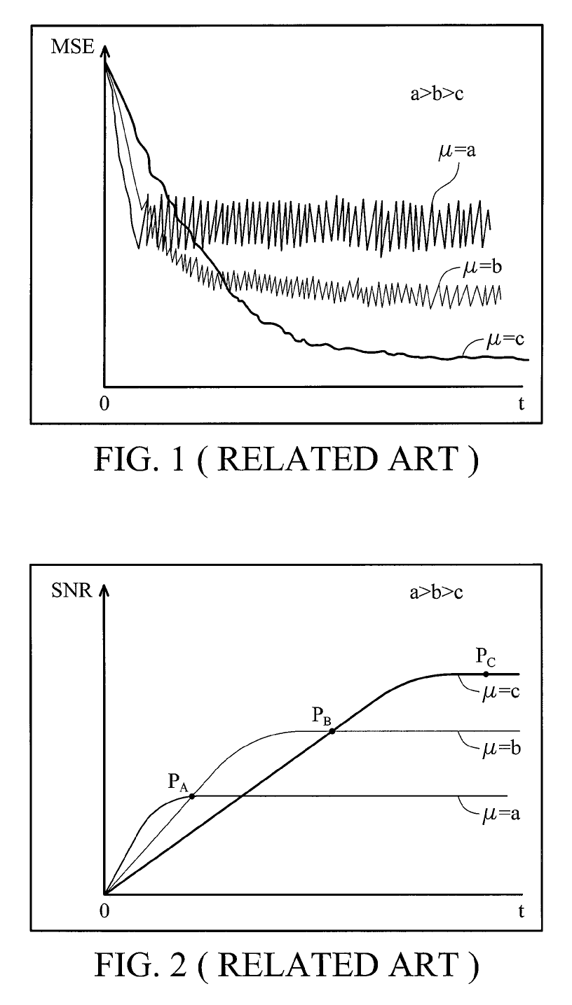

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

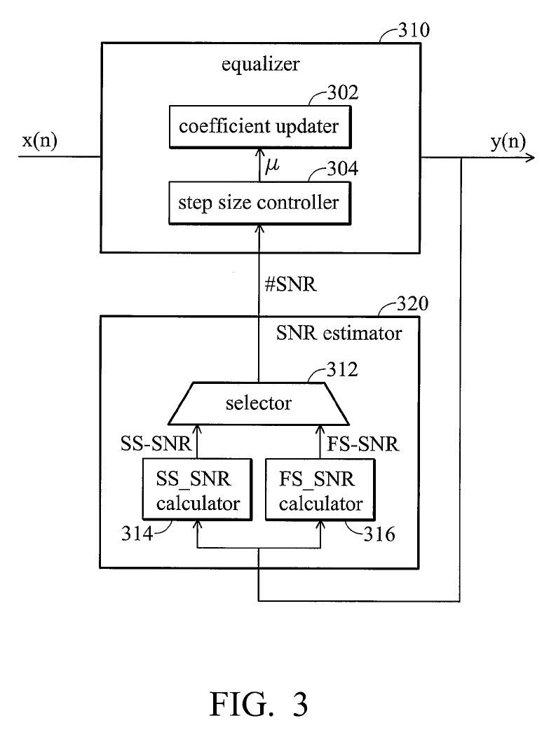

FIG. 3 shows an embodiment of a equalization circuit receiving a received symbol x(n) to generate an equalizer output y(n). An equalizer 310 performs equalization on the received symbol x(n) based on a SNR value of the equalizer output y(n). A SNR estimator 320 is coupled to the output of equalizer 310, receiving the equalizer output y(n) to measure the SNR value. The equalizer 310 equalizes the received symbol x(n) by the LMS algorithm in which coefficients are recursively updated by a step size, and the step size is dynamically adjusted based on the SNR value from SNR estimator 320. Specifically, when the equalization circuit is initialized, a largest step size is used, such as μ=a in FIG. 2. A rapid convergence rate is gained from the large step size, and when the SNR saturates at point P_{A}, the second step size μ=b is used, thus the SNR can be increased with a less rapid convergence rate. Similarly, when the SNR saturates at point P_{B} of FIG. 2, switching the step size μ from b to a lower value c, further increasing the SNR to a higher saturation level. In this way, the equalization can generate high SNR output with efficient convergence rate.

The equalizer 310 comprises a coefficient updater 302 and a step size controller 304. The coefficient updater 302 continuously updates the coefficients based on the step size. The step size controller 304, coupled to the coefficient updater 302, continuously receives the SNR value to calculate the step size for the coefficient updater 302. The SNR value is periodically measured and sent to the equalizer 310, and the period may be an interval of a segment. According to VSB standard, 832 symbols are sent every segment, with the first four symbols defined as segment syncs. The segment syncs comprise known data patterns provided for segment synchronization, and SNR of the symbol can also be estimated therefrom. The step size controller 304 analyzes variation between at least two consecutive SNR values sent from the SNR estimator 320, to determine whether the step size requires adjustment. If so, the step size controller 304 reduces the step size to a lower level, otherwise the step size is left as is. For example, if the SNR on μ=a curve reaches point P_{A}, the saturation is detected by step size controller 304, whereby the variation is below a threshold, and the step size is adjusted accordingly.

The SNR may have an upper limit, such as point P_{C} in FIG. 2. When the upper limit is reached, no matter how the step size decreases, the SNR does not further increase. To avoid the step size being over-reduced, the step size controller 304 further determines whether the most current step size reduction is effective. If not, the step size is not reduced.

The equalizer output y(n) comprises a field sync stream every 313 segments, comprising 832 known symbol values utilized for field synchronization. The field sync stream can also be utilized to estimate SNR, obtaining a value referred to as a field sync SNR. On the contrary, a SNR estimated from segment sync is referred to as a segment sync SNR. The field sync SNR is generated every 313 segments, and the segment sync SNR is generated every segment. The SNR estimator 320 outputs a SNR value every segment period, and the SNR value is selected from the field sync SNR or the segment sync SNR. In the SNR estimator 320, a field sync SNR calculator 316 estimates the field sync SNR from the field sync symbol stream occurring every 313 segments, and a segment sync SNR calculator 314 periodically estimates the segment sync SNRs from the segment syncs every segment. Since the segment sync SNR is estimated from a short pattern, the possibility of erroneous result is considerable. On the contrary, the field sync SNR is a more stable and reliable value despite not being updated in real time. In the embodiment, a combined SNR measurement is provided to avoid erroneous estimation. The segment sync SNR is normally output as the SNR value, and if the difference between the segment sync SNR and the field sync SNR is too large, the segment sync SNR is deemed inaccurate, and the field sync SNR is output instead. The selector 312 is coupled to the segment sync SNR calculator 314 and field sync SNR calculator 316, performing the selection by comparing the segment sync SNR with the field sync SNR every segment period. If the difference of the segment sync SNR and the field sync SNR exceeds a predetermined threshold, the selector 312 selects and outputs the field sync SNR as the SNR value, otherwise the selector 312 outputs the segment sync SNR as the SNR value.

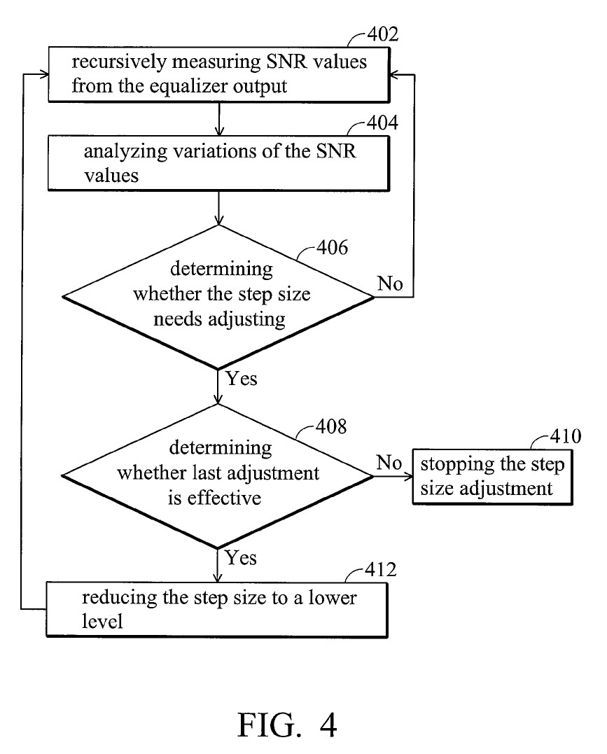

FIG. 4 is a flowchart of step size determination according to an embodiment of the invention. In step 402, SNR values are recursively measured from the equalizer output. In step 404, variation between at least two consecutive SNR values is analyzed. In step 406, the necessity to adjust the step size is determined based on the variation analysis. If necessary, the step proceeds to step 408, determining whether the most recent adjustment is effective. If no necessity is determined in step 406, the process returns to step 402. In step 408, if the most recent adjustment is not effective, step 410 stops the step size adjustment. Otherwise, step 412 is processed, reducing the step size to a lower level, and returning to step 402 for next SNR measurement.

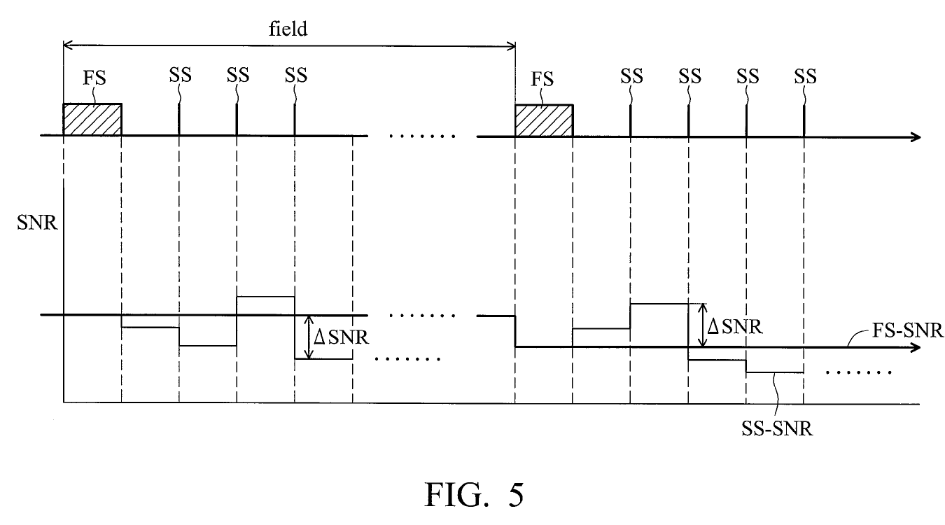

FIG. 5 is a diagram of field sync and segment sync with corresponding SNR values. A field sync FS and selector 312 segment syncs SS periodically occur along a time axis. Field sync SNR FS_SNR and segment sync SNR SS_SNR, are respectively measured as follows. The field sync SNR FS_SNR is a stable and reliable value remaining constant during the 313 segment periods. The segment syncs SNR SS_SNR are updated every segment, having higher possibility for error. The difference ΔSNR is checked every segment period, and if exceeding a predetermined level, the more reliable field sync SNR FS_SNR is output as the SNR value sent to step size controller 304 in FIG. 3.

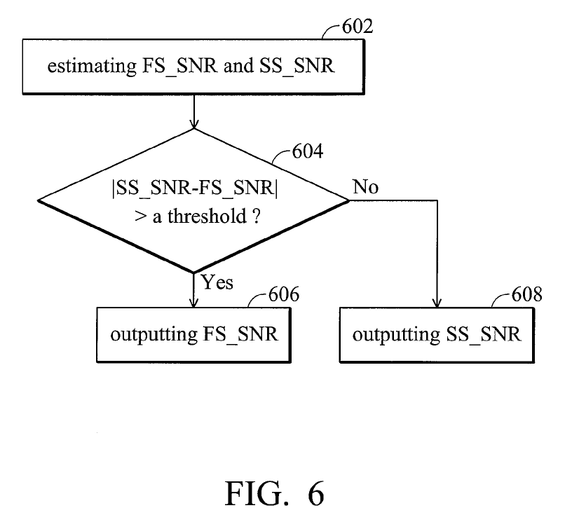

FIG. 6 is a flowchart of SNR measurement according to an embodiment of the invention. In step 602, a field sync SNR is estimated from the field sync symbol stream every 313 segments, and a segment sync SNR is estimated from the segment syncs every segment. In step 604, upon acquisition of a segment sync SNR, a comparison with the field sync SNR is performed, determining whether the difference therebetween exceeds a predetermined threshold. If so, step 606 is performed, outputting the field sync SNR as the SNR value. Otherwise, the segment sync SNR is selected as the SNR value in step 608.

As known, an equalizer may utilize a blind algorithm or a decision direct algorithm to filter input symbols, depending on the updating mode thereof. The updating mode may be determined according to the SNR value.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An equalization method, equalizing received symbols to generate an equalizer output, in which coefficients are updated by a step size based on LMS algorithm, the equalization method comprising:
recursively measuring SNR values from the equalizer output;
analyzing variation between at least two consecutive SNR values measured within a period;
determining a necessity to adjust the step size based on the variation analysis;
when the necessity is determined, reducing the step size to a lower level, otherwise leaving the step size as is; and
looping back to the SNR measurement.

2. The equalization method as claimed in claim 1, wherein the necessity is predicated upon the variation converging below a threshold.

3. The equalization method as claimed in claim 2, wherein step size reduction comprises:
determining whether the most recent step size reduction is effective; and
if not, leaving the step size as is; wherein:
the step size reduction is deemed effective if the SNR value increases after step size reduction.

4. The equalization method as claimed in claim 1, wherein:
the equalizer output comprises a field sync stream and a plurality of segments headed with segment sync symbols; and
measurement of SNR outputs a SNR value every segment period, comprising:
estimating a field sync SNR from the field sync symbol stream;
periodically estimating segment sync SNRs from the segment sync symbols in every segment;
upon acquisition of a segment sync SNR, comparing the segment sync SNR with the field sync SNR; and
if the difference of the segment sync SNR and the field sync SNR exceeds a predetermined threshold, outputting the field sync SNR as the SNR value, otherwise outputting the segment sync SNR as the SNR value.

5. An equalization circuit receiving a received symbol to generate an equalizer output, comprising:
an equalizer, performing equalization on the received symbol based on a SNR value of the equalizer output;
a SNR estimator, coupled to the equalizer output, receiving the equalizer output to measure the SNR value; wherein:
the equalizer equalizes the received symbol by the LMS algorithm in which coefficients are recursively updated by a step size; and
the step size is adjusted based on the SNR value.

6. The equalization circuit as claimed in claim 5, wherein the equalizer comprises:
a coefficient updater, continuously updating the coefficients based on the step size;
a step size controller, coupled to the coefficient updater, continuously receiving the SNR value to calculate the step size for the coefficient updater; wherein:
the SNR value is periodically measured and sent to the equalizer;
the step size controller analyzes variation between at least two consecutive SNR values measured within a period;
the step size controller determines a necessity to adjust the step size based on the variation analysis;
when the necessity is determined, the step size controller reduces the step size to a lower level, otherwise the step size is left as is.

7. The equalization circuit as claimed in claim 6, wherein the necessity is predicated upon the variation converging below a threshold.

8. The equalization circuit as claimed in claim 7, wherein:
the step size controller further determines whether the most recent step size reduction is effective, and if not, the step size is left as is; and
the step size reduction is deemed effective if the SNR value increases after step size reduction.

9. The equalization circuit as claimed in claim 6, wherein:
the equalizer output comprises a field sync stream and a plurality of segments headed with segment sync symbols; and
the SNR estimator outputs the SNR every segment period, comprising:
a field sync SNR calculator, estimating a field sync SNR from the field sync symbol stream;
a segment sync SNR calculator, periodically estimating segment sync SNRs from the segment sync symbols in every segment; and
a selector, coupled to the segment sync SNR calculator and field sync SNR calculator, comparing the segment sync SNR with the field sync SNR every segment period; wherein if the difference of the segment sync SNR and the field sync SNR exceeds a predetermined threshold, the selector outputs the field sync SNR as the SNR value, otherwise the selector outputs the segment sync SNR as the SNR value.

10. An equalization circuit receiving a received symbol to generate an equalizer output, comprising:
an equalizer, performing equalization on the received symbol based on a SNR value of the equalizer output; and
a SNR estimator, coupled to the equalizer output, receiving the equalizer output to measure the SNR value; wherein:
the equalizer equalizes the received symbol by the LMS algorithm in which coefficients are recursively updated according to the operation parameters; and
the operation parameters are adjusted in response to the SNR value.

11. The equalization circuit as claimed in claim 10, wherein:
the operation parameters determine an updating mode of the equalizer, indicating the equalizer to use a blind algorithm or a decision direct algorithm; and
the updating mode is determined according to the SNR value.

12. The equalization circuit as claimed in claim 11, further comprising a SNR estimator calculating the SNR value every segment period, comprising:
a field sync SNR calculator, estimating a field sync SNR from the field sync symbol stream;
a segment sync SNR calculator, periodically estimating segment sync SNRs from the segment sync symbols in every segment, and
a selector, coupled to the segment sync SNR calculator and field sync SNR calculator, comparing the segment sync SNR with the field sync SNR every segment period; wherein if the absolute value of difference of the segment sync SNR and the field sync SNR exceeds a predetermined threshold, the selector outputs the field sync SNR as the SNR value, otherwise the selector outputs the segment sync SNR as the SNR value.
